(19) United States
(12) Patent Application Publication
(10) Pub. No.: US 2011/0035665 A1
(43) Pub. Date: Feb. 10, 2011

(54) DIGITAL IMAGING PROCESSING APPARATUS, METHOD OF CONTROLLING THE SAME, AND RECORDING MEDIUM STORING PROGRAM TO EXECUTE THE METHOD

(75) Inventors: Hye-jin Kim, Seoul (KR); Jun-ho Choi, Seoul (KR); Sung-ho Eun, Seoul (KR); Na-ri Choi, Seoul (KR)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: Samsung Electronics Co., Ltd., Suwon-si (KR)

(21) Appl. No.: 12/852,199

(22) Filed: Aug. 6, 2010

(30) Foreign Application Priority Data
Aug. 7, 2009 (KR) 10-2009-0072957

(51) Int. Cl. G06F 3/01; G06F 3/041

(52) U.S. Cl. 715/702; 345/173

(57) ABSTRACT

A digital image processing apparatus that includes a touch screen recognizing a touch input of a user, a method of controlling the digital image processing apparatus, and a recording medium storing a program for executing the method are provided. An embodiment of the digital image processing apparatus includes a touch screen recognizing a touch input of a user; a time calculator calculating a time of the touch input of the user; and a GUI generator generating a GUI corresponding to the calculated touch input time.

### CROSS-REFERENCE TO RELATED PATENT APPLICATION

This application claims the benefit of Korean Patent Application No. 10-2009-0072957, filed on Aug. 7, 2009, in the Korean Intellectual Property Office, the disclosure of which is incorporated herein in its entirety by reference.

### BACKGROUND

Various embodiments of the invention relate to a digital image processing apparatus, a method of controlling the digital image processing apparatus, and a recording medium storing a program for executing the method, and more particularly, to a digital image processing apparatus including a touch screen that recognizes a touch input of a user, a method of controlling the digital image processing apparatus, and a recording medium storing a program for executing the method.

Recently, digital image processing apparatuses such as digital cameras and mobile phones having a camera have been implemented with a liquid crystal panel, such as a liquid crystal display (LCD), having a touch screen. A touch screen is a device that recognizes a touch of a user as a control command. Users who are not used to controlling digital devices may control the digital devices conveniently by using the touch screen.

As digital image processing apparatuses including touch screen functionality are being widely distributed, efforts for implementing various operations using a touch screen have been conducted. For example, various operations may be performed by using a long touch input, that is, touching the touch screen for a long time, as well as a tap input, that is, touching the touch screen for a short time.

However, users may not know what kinds of operations may be performed by touching the touch screen for a long time or how long the touch screen should be touched, and thus users may feel inconvenienced when using the touch screen.

### SUMMARY

Various embodiments of the invention provide a digital image processing apparatus having a touch screen that may be conveniently used by a user, a method of controlling the digital image processing apparatus, and a recording medium storing a program for executing the method.

According to an embodiment of the invention, there is provided a digital image processing apparatus including: a touch screen recognizing a touch input of a user; a time calculator calculating a touch input time of the touch input of the user; and a graphical user interface (GUI) generator generating a GUI corresponding to the calculated touch input time.

The GUI generator may generate a time GUI representing the touch input time. The time GUI may be denoted as a bar gauge or figure.

The GUI generator may generate a necessary time GUI representing a time required to recognize the touch input as a long touch input.

The GUI generator may generate a menu GUI representing menus selectable according to the touch input time.

The GUI generator may generate an activation window that denotes a currently selected menu according to the touch input time, and move the activation window to other menus from the currently selected menu as the touch input time increases.

According to another embodiment of the invention, there is provided a digital image processing apparatus including a touch screen recognizing a touch input of a user, the apparatus including: a touch determination unit determining a kind of the touch input from the user; a tap function performing unit performing a function corresponding to a tap input when the touch input is determined as the tap input; and a long touch function performing unit performing a function corresponding to the touch input time when the touch input is determined as the long touch input.

Touch determination unit may include: a time calculator calculating a touch input time; and a comparator comparing the calculated time with a reference.

The touch determination unit may determine the touch input as the tap input when the calculated time is less than the reference, and determine the touch input as the long touch input when the calculated time is equal to or greater than the reference.

The long touch function performing unit may divide the touch input time.

The digital image processing apparatus may further include a first GUI generator generating a time GUI that represents the touch input time when the touch input is the long touch input.

The digital image processing apparatus may further include a second GUI generator generating a menu GUI that represents functions selectable by the touch input when the touch input is the long touch input.

The second GUI generator may generate a plurality of menu icons as the menu GUI.

The time GUI may overlap with the plurality of menu icons, and the time GUI may be used as an activation window for selecting one of the menu icons.

According to another embodiment of the invention, there is provided a method of controlling a digital image processing apparatus that includes a touch screen recognizing a touch input of a user, the method including: determining a kind of the touch input of the user; performing a function corresponding to a tap input when the touch input is the tap input; and performing a function corresponding to the touch input time when the touch input is a long touch input.

The determining of the kind of touch input may include: calculating the touch input time; and determining the touch input as the tap input when the calculated time is less than a reference and determining the touch input as the long touch input when the calculated time is equal to or greater than the reference.

The method may further include displaying a time GUI that represents the continuous touch input time when the touch input time is the long touch input.

The method may further include displaying a menu GUI that represents functions selectable by the touch input when the touch input is the long touch input.

A plurality of menu icons may be generated as the menu GUI, and the time GUI may be used as an activation window for selecting one of the menu icons according to the touch input time.

According to another embodiment of the invention, there is provided a recording medium having embodied thereon the method for executing the above method.

### BRIEF DESCRIPTION OF THE DRAWINGS

The above and other features and advantages of various embodiments of the invention will become more apparent by describing in detail exemplary embodiments thereof with reference to the attached drawings in which:

FIG. 1 is a block diagram of a digital image processing apparatus according to an embodiment of the invention;

FIG. 2A is a pictorial diagram of an example of a long touch input in the digital image processing apparatus of FIG. 1;

FIG. 2B is a pictorial diagram of another example of a long touch input in the digital image processing apparatus of FIG. 1;

FIGS. 3A and 3B are pictorial diagrams illustrating an example of a tap input in the digital image processing apparatus of FIG. 1;

FIGS. 4A and 4B are pictorial diagrams of another example of the long touch input in the digital image processing apparatus of FIG. 1;

FIGS. 5A and 5B are pictorial diagrams of another example of the long touch input in the digital image processing apparatus of FIG. 1;

FIGS. 6A and 6B are pictorial diagrams of another example of the tap input in the digital image processing apparatus of FIG. 1;

FIGS. 7A and 7B are pictorial diagrams of another example of the long touch input in the digital image processing apparatus of FIG. 1; and

FIG. 8 is a flowchart illustrating a method of controlling the digital image processing apparatus according to an embodiment of the invention.

### DETAILED DESCRIPTION OF THE EMBODIMENTS

Hereinafter, embodiments of the invention will be described in detail with reference to accompanying drawings.

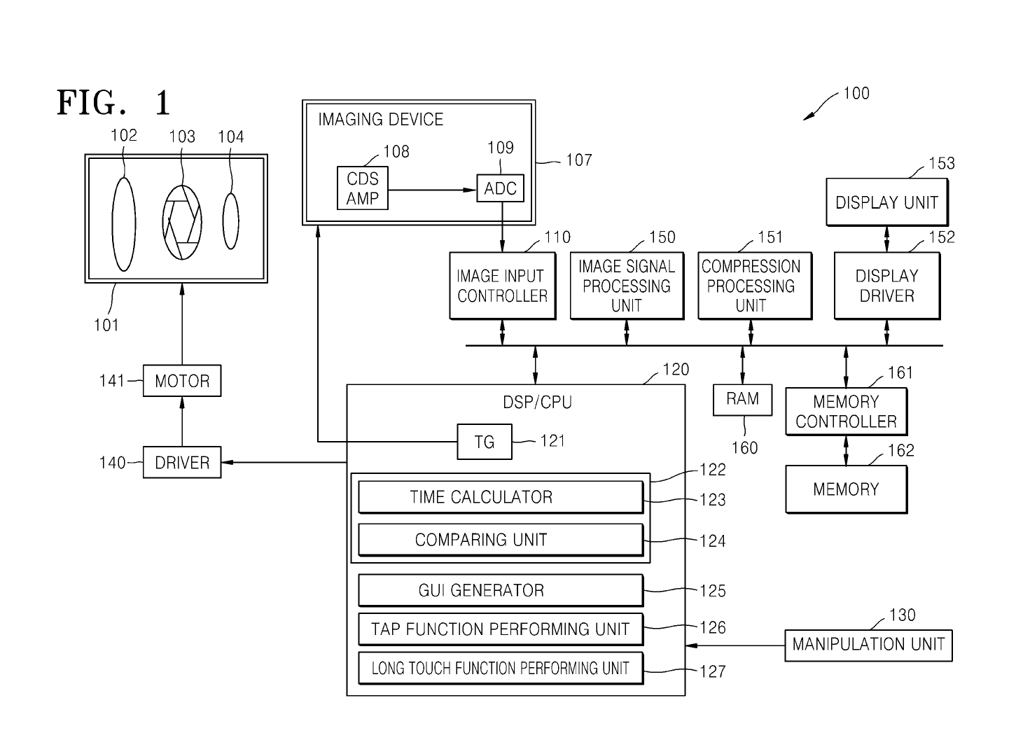

FIG. 1 is a block diagram of a digital image processing apparatus 100 according to an embodiment of the invention.

Referring to FIG. 1, the digital image processing apparatus 100 includes an optical imaging system 101, an imaging device 107, an image input controller 110, a digital signal processor (DSP)/central processing unit (CPU) 120, a manipulation unit 130, a driver 140, a motor 141, an image signal processor 150, a compression processor 151, a display driver 152, a display unit 153, a random access memory (RAM) 160, a memory controller 161, and a memory 162.

The optical imaging system 101 may include a zoom lens 102, an aperture 103, and a focus lens 104. The optical imaging system 101 is an optical system that focuses external optical information onto the imaging device 107, that is, transmits light from a subject onto the imaging device 107. The zoom lens 102 changes a viewing angle by varying a focal distance. The aperture 103 adjusts an amount of light transmitting through the optical imaging system 101, and is driven by the motor 141. The focus lens 104 focuses an image of the subject on an imaging surface of the imaging device 107 by moving in an optical axis direction. The aperture 103 and the focus lens 104 are driven by the motor 141. In FIG. 1, one driver 140 and one motor 141 are illustrated, however, the aperture 103 and the focus lens 104 may each correspond to a respective driver and motor. The motor 141 operates when receiving a driving signal from the driver 140.

The imaging device 107 may be a photoelectric conversion device, and includes a plurality of devices that convert optical information transmitted through the optical imaging system 101 into electric signals. Each of the devices in the imaging device 107 generates an electric signal according to the transmitted optical information. The imaging device 107 may be a charge coupled device (CCD) or a complementary metal oxide semiconductor (CMOS).

Moreover, a mechanical shutter (not shown) that blocks light during a non-photographing mode may be installed for controlling an exposure time of the imaging device 107. Otherwise, an electronic shutter (not shown) may be installed. The mechanical shutter or the electronic shutter may be operated by manipulating a shutter button (manipulation unit 130) connected to the DSP/CPU 120.

The imaging device 107 may include a correlated double sampling (CDS)/amplifier (AMP) unit 108 and an analog-digital converter (ADC) 109. The CDS/AMP unit 108 removes low frequency noise included in the electric signals output from the imaging device 107, and amplifies the electric signals to a predetermined level. The ADC 109 converts the electric signals output from the CDS/AMP unit 109 into digital signals. The ADC 109 outputs the digital signals to the image input controller 110.

The image input controller 110 processes the digital signals output from the ADC 109 to generate image signals. The image input controller 110 outputs the generated image signals to, for example, the image signal processor 150. In addition, the image input controller 110 controls reading/writing of image data from/into the RAM 160.

The optical imaging system 101, the imaging device 107, and the image input controller 110 may be a photographing unit that photographs the subject.

The DSP/CPU 120 performs as a calculation processing and controlling device according to a program, and controls processes of components installed in the digital image processing apparatus 100. That is, the DSP/CPU 120 is a control unit. For example, the DSP/CPU 120 controls the optical imaging system 101 by outputting a signal to the driver 140, for example, based on focus control or exposure control. In addition, the DSP/CPU 120 controls each of the components installed in the digital image processing apparatus 100 according to signals output from the manipulation unit 130. In the current embodiment, one DSP/CPU 120 is installed, however, the DSP/CPU 120 may include a plurality of CPUs for performing signal-based commands and control-based commands separately.

As shown in FIG. 1, the DSP/CPU 120 may include a timing generator TG 121, a touch determination unit 122, a graphical user interface (GUI) generator 125, a tap function performing unit 126, and a long touch function performing unit 127.

The TG 121 outputs a timing signal to the imaging device 107 or the CDS/AMP unit 108, and controls an exposure time of pixels of the imaging device 107 or reading of charges. In addition, the TG 121 outputs a unit clock when time is to be measured.

The touch determination unit 122 determines a kind of a touch input of the user when the touch input from the user is recognized. The kinds of touch input may include a tap input, that is, a relatively short period of touch from the user, and a long touch input, that is, a relatively long period of touch from the user. The touch determination unit 122 may include a time calculator 123 and a comparator 124.

The time calculator 123 calculates a time from recognition of touch to termination of touch. That is, the time calculator 123 calculates a touch input time during which a touch is input continuously. To calculate the touch input time, the time calculator 123 may use a timer installed in the digital image processing apparatus 100. The timer may be a system clock, for example, the unit clock output from the TG 121.

The comparator 124 compares the touch input time calculated by the time calculator 123 with a reference. When the touch input time calculated by the time calculator 123 is less than the reference, the comparator 124 determines that the touch input is the tap input. On the other hand, when the calculated touch input time is equal to or greater than the reference, the comparator 124 determines that the touch input is the long touch input. For example, if the reference is 0.5 second, when the calculated touch input time is 0.3 second, the touch input is determined to be the tap input, and when the calculated touch input time is 0.7 second, the touch input is determined to be the long touch input.

The GUI generator 125 generates a GUI corresponding to the touch input time. If the touch input of the user is the long touch input, a GUI representing the touch input time or selectable functions by the touch input, or both, is generated. The GUI generator 125 may include a first GUI generator and a second GUI generator (not shown).

If the touch input is the long touch input, the first GUI generator may generate a time GUI representing the touch input time. The time GUI may be represented by a bar gauge. Otherwise, the time GUI may be represented by a number. The bar gauge and the number are examples of representing the time GUI, and the time GUI may be variously modified as long as the user may recognize the touch input time from the time GUI.

In addition, the first GUI generator may further generate a necessary time GUI representing the touch input time required for a function to be performed. For example, if the digital image processing apparatus 100 includes a function of photographing the subject when a touch screen has been touched for 3 seconds in a photographing mode, when the touch input is applied by the user, the necessary GUI representing the touch input time required for the photographing to be performed and the time GUI representing the touch input time are generated simultaneously and displayed on the display unit 153.

Also, if the touch input is the long touch input, the second GUI generator may generate a menu GUI representing menus and functions that may be selected or executed by the long touch input. The menu GUI may include a plurality of menu icons. In an embodiment, menu icons may include, without limitation, graphics, text, symbols or other visual indicators corresponding to items in a menu. For example, when the user touches an icon that may set flash conditions, menu icons relating to the flash conditions (for example, compulsive flash, flash off, and red-eye reduction) are generated and displayed when the touch input is recognized as the long touch input.

On the other hand, the time GUI generated by the first GUI generator may overlap with the menu GUI generated by the second GUI generator. At this time, the time GUI may function as an activation window for selecting one of the menu icons. In addition, since the time GUI may be represented as a bar gauge having a length of which that changes as time elapses, a selected menu icon may be changed according to the touch input time.

The tap function performing unit 126 performs functions corresponding to the tap input when the touch input from the user is the tap input. That is, when the user quickly touches an icon displayed on the touch screen, a function corresponding to the touched icon is executed. For example, when the user touches a folder icon, sub-icons or files included in the folder icon may be displayed. Otherwise, in the photographing mode, when the user touches an icon representing a photographing condition, various selectable functions relating to the photographing condition may be displayed.

The long touch function performing unit 127 performs a function corresponding to the touch input time when the touch input from the user is the long touch input. For selecting one of various functions according to the touch input time, the long touch function performing unit 127 may divide the touch input time into a plurality of sections, each of which may match with one of the various functions in a one to one correspondence.

The manipulation unit 130 may include a power button and a shutter button (not shown) installed on the digital image processing apparatus 100. In addition, since the digital image processing apparatus 100 of the current embodiment includes the touch screen, icons displayed on the touch screen may function as buttons as part of the manipulation unit 130.

The image signal processor 150 receives image signals from the image input controller 110, and generates image signals that may be processed according to a white balance (WB) control value, a gamma γ value, or a contour emphasizing value.

The compression processor 151 receives the image signals from the image signal processor 150, and compresses the image signals into a joint photographic experts group (JPEG) compression format, a Lempel-Ziv-Welch (LZW) compression format, or etc. The compression processor 151, for example, transmits the compressed image data to the memory controller 161. Therefore, the compression processor 151 may be an image file generator.

The display driver 152 receives image data from the RAM 160, and displays the image data on the display unit 153. The image displayed on the display unit 153 may be, for example, a preview image read from the RAM 160 (a live view image), a setting screen of the digital image processing apparatus 100, or a recorded image. In addition, the display unit 153 may display the time GUI or the menu GUI generated by the GUI generator 125. The display unit 153 and the display driver 152 may be respectively an LCD and an LCD driver. However, embodiments of the invention are not limited to the above example, and the display unit 153 and the display driver 152 may be instead an organic electroluminescent (EL) display and a driver of the organic EL display, respectively.

In the digital image processing apparatus 100 of the current embodiment, the display unit 153 may include the touch screen sensing the touch of the user. The touch screen may be additionally mounted on a surface of the display unit 153, such as the LCD, or may be built in the display unit 153. In addition, the touch screen may be realized in various ways, for example, a capacitive type touch screen, a resistive type touch screen, or an optical sensing type touch screen.

The RAM 160 temporarily stores various data. Although it is not shown in FIG. 1, the RAM 160 may include a video RAM (VRAM) for displaying images and a synchronous dynamic RAM (SDRAM) that temporarily stores image data of recorded images.

The memory controller 161 controls writing of image data into the memory 162 and reading of image data or setting information from the memory 162. The memory 162 may be an optical disc such as a compact disc (CD), a digital versatile disc (DVD), or a blue-ray disc, an optical magnetic disc, a magnetic disc, or a semiconductor recording medium for storing recorded image data. The image data may be image files generated by the compression processor 151. The memory controller 161 and the memory 162 may be detachable from the digital image processing apparatus 100.

A series of processes performed in the digital image processing apparatus 100 may be executed by hardware or software such as a program stored in a computer.

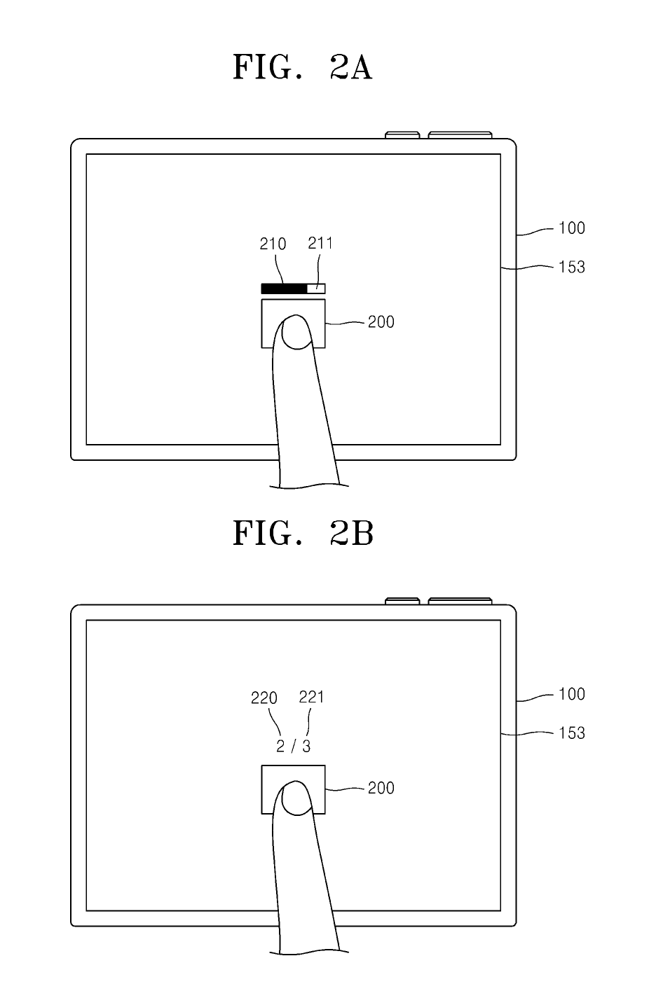

Performing functions according to the touch input of the user according to various embodiments will be described with reference to FIGS. 2A through 7B.

FIG. 2A is a diagram of an example of the long touch input, in particular, one function is performed when the long touch input is applied.

In FIG. 2A, the touch input of the user is performed in the photographing mode, and a shutter function is performed when the touch input lasts for three seconds. When the user touches the touch screen, a focus contour 200 may be generated around where the user is touching the touch screen. In addition, when the touch input is determined as the long touch input, a bar gauge 210 is generated as the time GUI representing the touch input time and displayed on the touch screen. In addition, a GUI 211 representing the time required for the shutter function to be performed may be generated and displayed overlapping with the bar gauge 210. The length of the bar gauge 210 corresponds to the current touch input time, and when the length of the bar gauge 210 becomes the same as the length of the GUI 211, the shutter function is performed. That is, the subject is photographed.

FIG. 2B is a diagram of another example of the long touch input, and in FIG. 2B, one function is performed when the long touch input is applied like in FIG. 2A.

FIG. 2B also shows an example of performing the shutter function in the photographing mode. When a touch is input from the user, the focus contour 200 may be generated around where the user is touching the touch screen. In addition, when the touch input is the long touch input, a figure 220 is displayed as the time GUI, representing the touch input time. In addition, a GUI 221 representing the touch input time required for the shutter function to be performed may be generated and displayed with the figure 220. The figure 220 increases as time passes by, and when the figure 220 is equal to the GUI 221, the function of the long touch input is performed. That is, the subject is photographed.

FIGS. 2A and 2B show examples in which the time GUI is the bar gauge or the figure, however, embodiments of the invention are not limited to the above examples.

As described above, when the long touch is input, the user may recognize how long he/she has touched the touch screen and how long the touch screen should be touched.

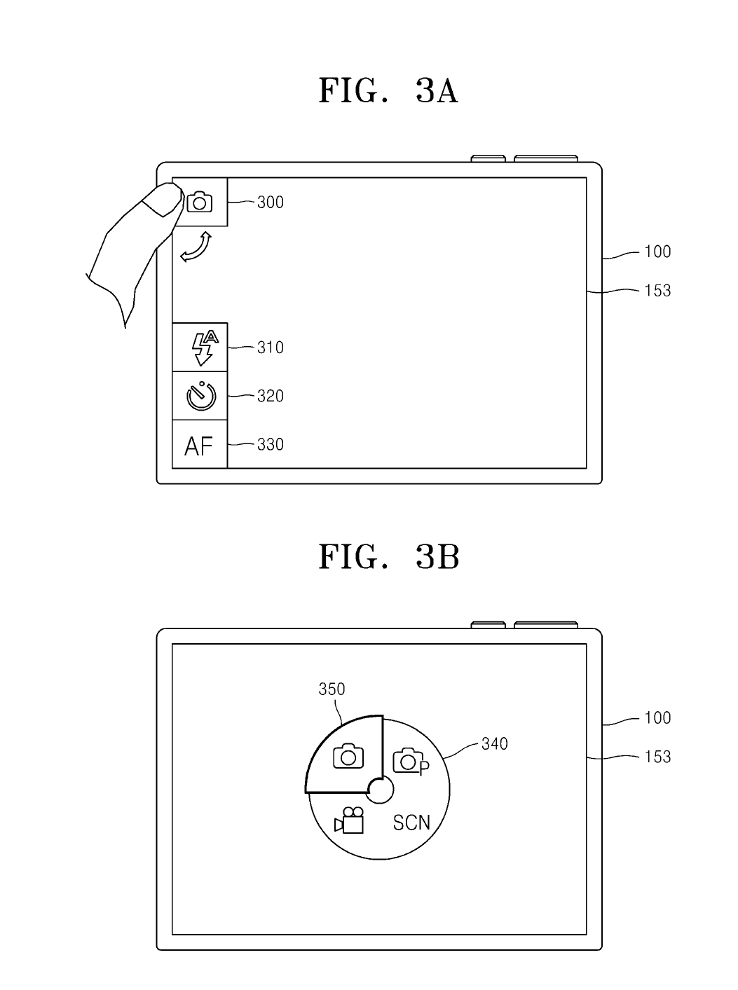

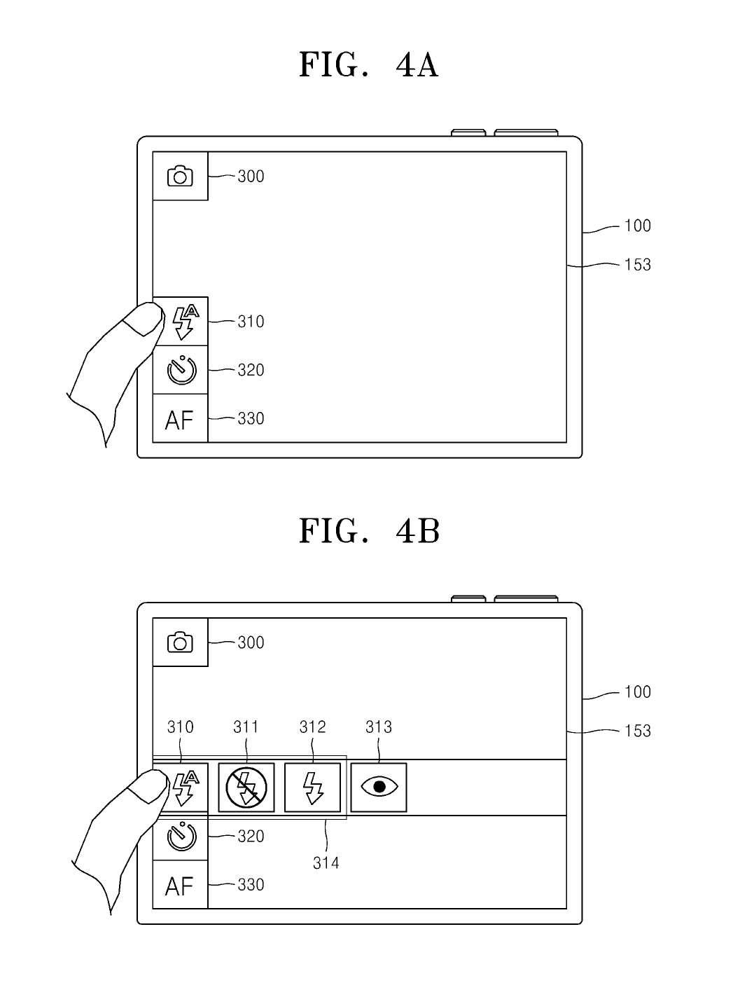

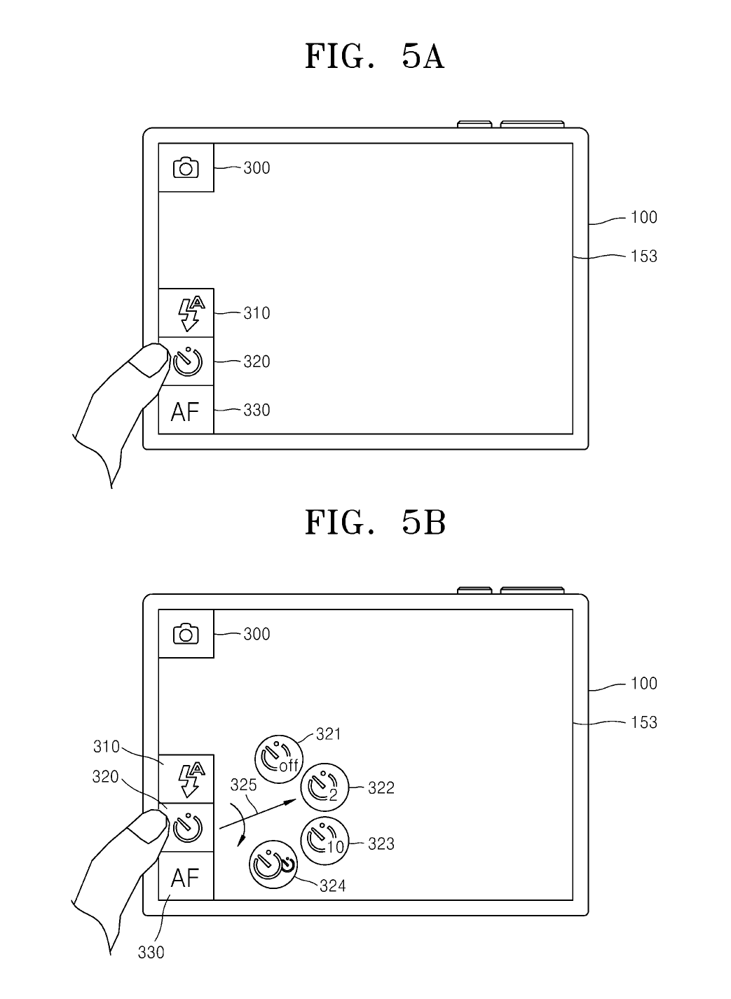

FIGS. 3A and 3B are diagrams showing an example of the tap input, and FIGS. 4A through 5B are diagrams showing an example of the long touch input.

Referring to FIG. 3A, in the photographing mode, various icons 300, 310, 320, and 330 are displayed on the touch screen. For example, when the user quickly touches a mode selection icon 300 displayed on an upper left portion of the touch screen, it is determined that the tap input is applied to the touch screen.

When the touch is determined as the tap input, icons 340 representing various modes are displayed as shown in FIG. 3B. For example, the icons 340 may include icons representing a general photographing mode, a program photographing mode, a scene mode, and a moving picture mode. In addition, since the general photographing mode is selected currently, an activation window 350 overlaps with the icon representing the general photographing mode so that the user may recognize the currently selected mode.

That is, as shown in FIGS. 3A and 3B, when the tap input is applied to the touch screen, the functions performed by the general touch input may be performed.

Referring to FIG. 4A, when the user continuously contacts the icon 310 representing a flash mode in the photographing mode, it is determined that the long touch input is applied to the touch screen.

When the touch of the user is determined as the long touch input, various modes relating to the touched mode icon are displayed as shown in FIG. 4B. In the current embodiment, an icon 311 representing a flash off mode, an icon 312 representing a compulsive flash mode, and an icon 313 representing a red-eye reduction mode may be displayed, as well as the icon 310 representing an auto-flash mode, which is currently selected.

In an embodiment, when a user touches an icon representing a menu or menu item, such as icons 300, 310, 320 and 330 of FIG. 4A, icons corresponding to other menu items or submenus are displayed. For example, in the embodiment of FIG. 4B, when the user touches icon 310, icons corresponding to menu items 311, 312 and 313 are also displayed. In an embodiment, the icons may include graphics, text, symbols and/or combinations of one or more of the foregoing.

In addition, an activation window 314 that may vary depending on the touch input time may be generated and displayed with the icons 310, 311, 312, and 313 representing various modes. The activation window 314 overlaps with the icon 310 representing the auto-flash mode, which is located on the left and where the activation window 314 starts, and then a size of the activation window 314 gradually increases as the touch input time increases. Then, the activation window 314 may cover the icon 312 representing the compulsive flash mode as shown in FIG. 4B. In the current embodiment, the size of the activation window 314 is gradually increased; however, embodiments of the invention are not limited thereto. Instead, the size of the activation window may be fixed, and the location of the activation window may be changed as time passes by to change the selected mode.

On the other hand, in FIG. 5A, the user applies the long touch input to the icon 320 representing a timer mode. In the current embodiment, when the long touch input is applied from the user to the touch screen, various icons relating to the timer mode such as an icon 321 representing a timer off mode, an icon 322 representing a two-second timer mode, an icon 323 representing a 10-second timer mode 323, and an icon 324 representing a double-timer mode, in which the photographing is performed twice, are displayed.

In addition, an activation window 325 that varies depending on the touch input time may be generated and displayed with the icons 321, 322, 323, and 324 representing various modes. The activation window 325, which varies depending on the touch input time, may be formed as an arrow. As the touch input time increases, the direction of the arrow may be changed, and accordingly, different modes may be selected. In the current embodiment, the direction of the activation window 325 is changed according to the touch input time; however, embodiments of the invention are not limited thereto. The activation window 325 may be variously modified as long as the activation window 325 may denote the currently selected mode among the various mode icons.

As described above, the user may recognize the available functions that may be performed by the long touch input while applying the long touch input to the touch screen, and the user also may recognize how long he/she has touched the screen and how long the touch screen should be touched.

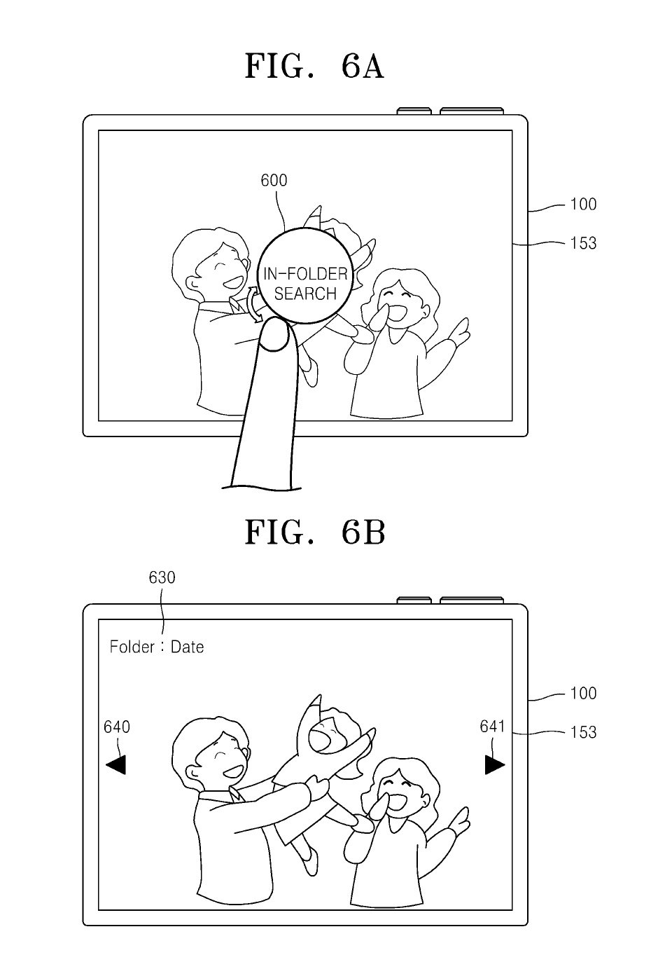

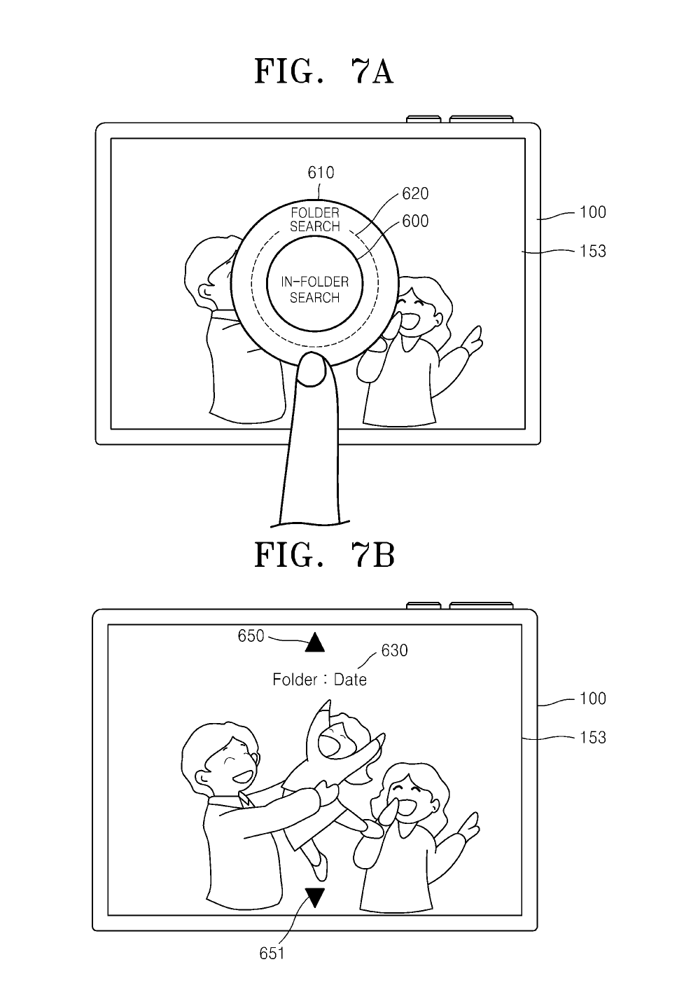

FIGS. 6A and 6B are diagrams showing another example of the tap input, and FIGS. 7A and 7B are diagrams showing another example of the long touch input.

Referring to FIG. 6A, an image that was recorded most recently is displayed on the display unit 153 in a reproducing mode. In addition, an icon 600 representing a function that is performed according to the tap input is displayed on a center portion of the display unit 153. When the user quickly touches the icon 600, it is determined that the tap input is applied to the touch screen.

As described above, when it is determined that the tap input is applied to the touch screen, the function represented by the icon 600, that is, a function for searching for images within a folder, is executed. In the current embodiment, as shown in FIG. 6B, a folder 630 including the currently displayed image and icons 640 and 641 for changing the currently displayed image are displayed on the display unit 153. When the user touches the icon 640 or 641, the user may display a previous image or a following image in the current folder 630.

FIGS. 7A and 7B illustrate a case where the long touch input is applied to the touch screen under the same circumstance as FIG. 6A. Referring to FIG. 7A, when the user continuously touches the icon 600 displayed on the center portion of the display unit 153 in the reproducing mode, it is determined that the long touch input is applied to the touch screen.

Then, an icon 610 representing a function of ‘folder search’ that may be performed by the long touch input is additionally generated. In addition, a time GUI 620 representing the long touch input time is generated between the icon 600 representing ‘in-folder search’ and the icon 610 representing ‘folder search’. As the touch input time increases, a size of the time GUI 620 increases, and when the time GUI 620 reaches a boundary of the icon 610, the function for searching for folders is executed. That is, as shown in FIG. 7B, the currently selected folder 630 and icons 650 and 651 for changing the folder are displayed on the display unit 153. When the user touches the icon 650 or 651, the user may search through other folders.

As described above, different functions may be performed on the same screen according to whether the touch input from the user is the tap input or the long touch input. In addition, the user may intuitively know which functions may be executed by the long touch input, and also know how long he/she has touched the screen and how long the screen should be touched to execute a certain function.

According to the above described digital image processing apparatus 100 including the touch screen, the user may conveniently use the functions that may be executed by the long touch input. In particular, the user may intuitively recognize how long he/she has touched the touch screen and how long the touch screen should be touched in order to execute a function. Also, the user may recognize the menus or functions executable by the long touch input.

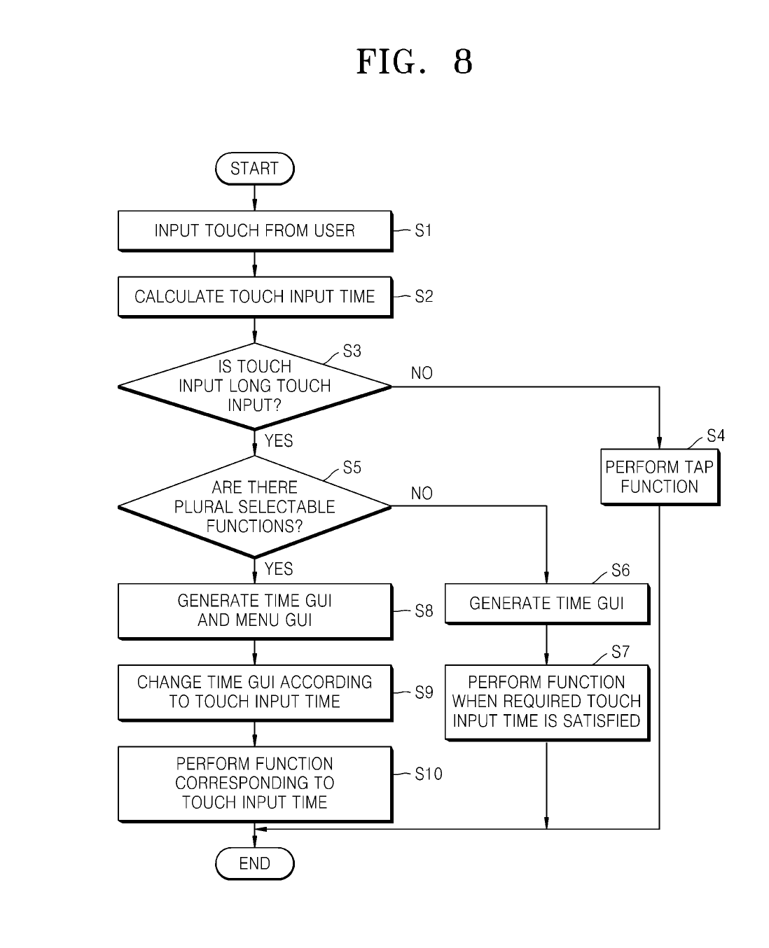

FIG. 8 is a flowchart illustrating a method of controlling a digital image processing apparatus according to an embodiment of the invention.

Referring to FIG. 8, when there is a touch input from the user in operation S1, touch input time is measured in operation S2. The touch input time is the time the touch screen has been continuously touched by the user.

While measuring the touch input time, the kind of touch input from the user is determined in operation S3. That is, it is determined whether the touch input is the tap input or the long touch input. The determination of the touch input may be performed by comparing the measured touch input time with a reference. That is, when the touch input time is less than the reference, the touch input of the user is determined as the tap input, and when the touch input time is equal to or greater than the reference, the touch input of the user is determined as the long touch input.

If it is determined that the tap input is applied from the user to the touch screen, the function of the tap input is executed in operation S4.

On the other hand, if it is determined that the long touch input is applied to the touch screen, the function corresponding to the touch input time is executed. To do this, it is determined whether a plurality of functions are selectable by the long touch input with respect to the menu to which the touch input is applied in operation S5.

If one function may be selectable, as shown in FIGS. 2A and 2B, the time GUI representing the touch input time is generated and displayed on the display unit in operation S6. In addition, when the touch input time from the user satisfies the time required to execute the above one function, the above function is executed in operation S7. That is, in the example illustrated in FIGS. 2A and 2B, if the touch input lasts for three seconds, the shutter function is executed automatically and the subject is photographed.

On the other hand, if there is a plurality of selectable functions, the time GUI representing the touch input time and the menu GUI representing the selectable functions are generated and displayed in operation S8. A plurality of menu icons may be generated as the menu GUI. In addition, the time GUI and the menu GUI may overlap with each other, and in this case, the time GUI changes according to the (current) touch input time and may be an activation window for selecting one of the menu icons. The size or shape of the time GUI varies depending on the touch input time in operation S9.

When the touch input of the user is stopped, the function corresponding to the touch input time is performed in operation S10. That is, selection menu icon by the time GUI is performed according to the touch input time. In the example illustrated in FIGS. 4A and 4B, the flash mode is changed from the auto-flash mode to the compulsory flash mode.

According to the method of controlling the digital image processing apparatus of an embodiment of the invention, the user may easily use the long touch input function, which is activated by touching the touch screen for a long time. In particular, the user may intuitively know how long he/she has touched the touch screen and how long the touch screen should be touched in order to execute the function corresponding to the long touch input. In addition, the user may recognize the menus or functions that may be selectable by the long touch input.

A program for executing the controlling method in the digital image processing apparatus may be stored in a recording medium. Examples of the readable recording medium include the memory 162 of FIG. 1, magnetic storage media (e.g., ROM, floppy disks, hard disks, etc.), and optical recording media (e.g., CD-ROMs, or DVDs).

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

While various embodiments of the invention may be described in terms of functional block components, such functional blocks may be realized by any number of hardware and/or software components configured to perform the specified functions. For example, the invention may employ various integrated circuit components, processing elements, logic elements, etc.

The particular implementations shown and described herein are illustrative examples of the invention and are not intended to otherwise limit the scope of the invention in any way. The connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”.

The use of the terms “a” and “an” and “the” and similar referents in the context of describing the invention (especially in the context of the following claims) are to be construed to cover both the singular and the plural. Furthermore, the steps of all methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed.

While various embodiments of the invention have been particularly shown and described with reference to exemplary embodiments thereof, it will be understood by those of ordinary skill in the art that various changes in form and details may be made therein without departing from the spirit and scope of the invention as defined by the following claims.

What is claimed is:

1. A digital image processing apparatus comprising:
a touch screen that recognizes a touch input of a user;
a time calculator that calculates a touch input time of the touch input of the user; and
a graphical user interface (GUI) generator that generates a GUI corresponding to the calculated touch input time.

2. The digital image processing apparatus of claim 1, wherein the GUI generator generates a time GUI representing the touch input time.

3. The digital image processing apparatus of claim 2, wherein the time GUI is denoted as one of bar gauge and figure.

4. The digital image processing apparatus of claim 3, wherein the GUI generator generates a necessary time GUI representing a time required to recognize the touch input as a long touch input.

5. The digital image processing apparatus of claim 1, wherein the GUI generator generates a menu GUI with menu icons selectable according to the touch input time.

6. The digital image processing apparatus of claim 5, wherein the GUI generator generates an activation window that corresponds to a currently selected menu icon according to the touch input time, and alters the activation window to correspond to other menu icons as the touch input time increases.

7. A digital image processing apparatus including a touch screen that recognizes a touch input of a user, the apparatus comprising:
a touch determination unit that determines if the touch input from the user is one of a tap input and a long touch input;
a tap function performing unit that performs a first function if the touch input is a tap input; and
a long touch function performing unit that performs a second function based on a touch input time if the touch input is a long touch input.

8. The digital image processing apparatus of claim 7, wherein the touch determination unit comprises:
a time calculator calculating the touch input time; and
a comparator comparing the calculated touch input time with a reference.

9. The digital image processing apparatus of claim 8, wherein the touch determination unit determines that the touch input is a tap input when the calculated touch input time is less than the reference, and determines that the touch input is a long touch input when the calculated touch input time is at least equal to the reference.

10. The digital image processing apparatus of claim 7, wherein the long touch function performing unit divides the touch input time.

11. The digital image processing apparatus of claim 7, further comprising a first GUI generator generating a time GUI that represents the touch input time when the touch input is a long touch input.

12. The digital image processing apparatus of claim 11, further comprising a second GUI generator generating a menu GUI with functions selectable by the touch input when the touch input is a long touch input.

13. The digital image processing apparatus of claim 12, wherein the second GUI generator generates a plurality of menu icons as the menu GUI.

14. The digital image processing apparatus of claim 13, wherein the time GUI is an activation window for selecting one of the menu icons.

15. A method of controlling a digital image processing apparatus that includes a touch screen recognizing a touch input of a user, the method comprising:
determining that the touch input is one of a tap input and a long touch input;
performing a first function if the touch input is determined to be a tap input; and
performing a second function based on a touch input time if the touch input is a long touch input.

16. The method of claim 15, wherein determining that the touch input is one of a tap input and a long touch input comprises:
calculating the touch input time; and
determining that the touch input is a tap input when the calculated time is less than a reference and determining that the touch input is a long touch input when the calculated time is at least equal to the reference.

17. The method of claim 15, further comprising displaying a time GUI that represents the touch input time when the touch input time is a long touch input.

18. The method of claim 17, further comprising displaying a menu GUI with functions selectable by the touch input when the touch input is a long touch input.

19. The method of claim 18, wherein a plurality of menu icons are generated as the menu GUI, and the time GUI is an activation window for selecting one of the menu icons according to the touch input time.

20. A recording medium having recorded thereon a program for executing the method of claim 15.
